(19) United States
(12) Patent Application Publication
(10) Pub. No.: US 2012/0033127 A1
(43) Pub. Date: Feb. 9, 2012

(54) IMAGE CAPTURE APPARATUS

(75) Inventor: MASAAKI UENISHI, Kawasaki-shi (JP)

(73) Assignee: CANON KABUSHIKI KAISHA, Tokyo (JP)

(21) Appl. No.: 13/179,610

(22) Filed: Jul. 11, 2011

(30) Foreign Application Priority Data
Aug. 9, 2010 (JP) 2010-179009
Jun. 14, 2011 (JP) 2011-132710

(51) Int. Cl. H04N 5/232

(52) U.S. Cl. 348/345; 348/E05.045

(57) ABSTRACT

An image capture apparatus comprises an image sensor, a detection unit which detects an object area based on at least one of color information and luminance information of an image obtained from the image sensor, a setting unit which sets a plurality of focus detection areas, with reference to the object area detected by the detection unit, a selection unit which selects a focus detection area from the plurality of focus detection areas, and a focus adjusting unit which performs focus adjustment by moving the imaging optical system based on the output signal from the image sensor in the focus detection area, wherein an overall range of the plurality of focus detection areas is wider than the object area, and each of the plurality of focus detection areas is smaller than a minimum size which can be set for the object area.

### BACKGROUND OF THE INVENTION

1. Field of the Invention

The present invention relates to an autofocusing technique used in image capture apparatuses such as a digital camera and a video camera.

2. Description of the Related Art

A technique of tracking a moving object based on color information or luminance information in a video signal has conventionally been proposed. At this time, the user must continue to focus on the moving object being tracked.

For example, Japanese Patent Laid-Open No. 2005-338352 proposes an autofocusing apparatus which changes the range of AF area so as to track movement of a designated target object. Also, Japanese Patent Laid-Open No. 2005-141068 proposes an automatic focus adjusting apparatus which sets a plurality of distance measurement areas, and adds focus evaluation values for distance measurement areas selected based on each focus evaluation value, thereby allowing distance measurement with high accuracy. Moreover, Japanese patent Laid-Open No. 5-145822 proposes a moving object tracking apparatus which determines a tracking area for an object from the same video signal, and performs its AF control using specific frequency components in this area.

However, in Japanese patent Laid-Open No. 2005-338352, if, for example, a tracking area “a” includes a portion other than the target object, such as the background, as shown in FIG. 8A, the apparatus may not be able to focus on the target object as, for example, it is focused on the background.

Also, in Japanese Patent Laid-Open No. 2005-141068, when the user continues to focus on a moving object assuming that this object is moving across the entire frame, it is necessary to set the entire frame as a distance measurement area, requiring considerable processing time.

Furthermore, in Japanese Patent Laid-Open No. 5-145822, AF control must be performed by determining an object area and then calculating specific frequency components in this area, requiring considerable processing time.

### SUMMARY OF THE INVENTION

The present invention has been made in consideration of the above-mentioned problems, and tracks an object, designated by the user, within a shortest possible period of time so as to continue to focus on the object.

According to the present invention, there is provided an image capture apparatus comprising: an image sensor which photo-electrically converts an object image formed by an imaging optical system; a detection unit which detects an object area, in which a target object to be focused exists, on a frame of the image sensor, based on at least one of color information and luminance information of an image obtained from an output signal from the image sensor; a setting unit which sets a plurality of focus detection areas, used to detect a focus state of the imaging optical system, with reference to the object area detected by the detection unit; a selection unit which selects a focus detection area, in which the target object exists, from the plurality of focus detection areas; and a focus adjusting unit which performs focus adjustment by moving the imaging optical system based on the output signal from the image sensor in the focus detection area selected by the selection unit, wherein an overall range of the plurality of focus detection areas is wider than the object area, and each of the plurality of focus detection areas is smaller than a minimum size which can be set for the object area.

Further features of the present invention will become apparent from the following description of exemplary embodiments with reference to the attached drawings.

### BRIEF DESCRIPTION OF THE DRAWINGS

FIG. 1 is a block diagram showing the configuration of an image capture apparatus according to the first embodiment of the present invention;

FIG. 2 is a flowchart showing the operation of the image capture apparatus according to the first embodiment of the present invention;

FIG. 3 is a flowchart for explaining a tracking-in-progress AF operation in FIG. 2;

FIG. 4 is a flowchart for explaining a focus determination operation in FIG. 2;

FIG. 5 is a graph for explaining focus determination in FIG. 3;

FIG. 6 is a flowchart for explaining frame selection & focus movement in FIG. 3;

FIG. 7 is a flowchart for explaining a normal AF operation in FIG. 2;

FIGS. 8A, 8B, and 8C are views for explaining setting of a plurality of AF frames in FIG. 3;

FIGS. 9A and 9B are flowcharts for explaining a tracking-in-progress AF operation in FIG. 2 according to the second embodiment; and

FIGS. 10A, 10B, and 10C are views for explaining setting of a plurality of AF frames in FIG. 9.

### DESCRIPTION OF THE EMBODIMENTS

### First Embodiment

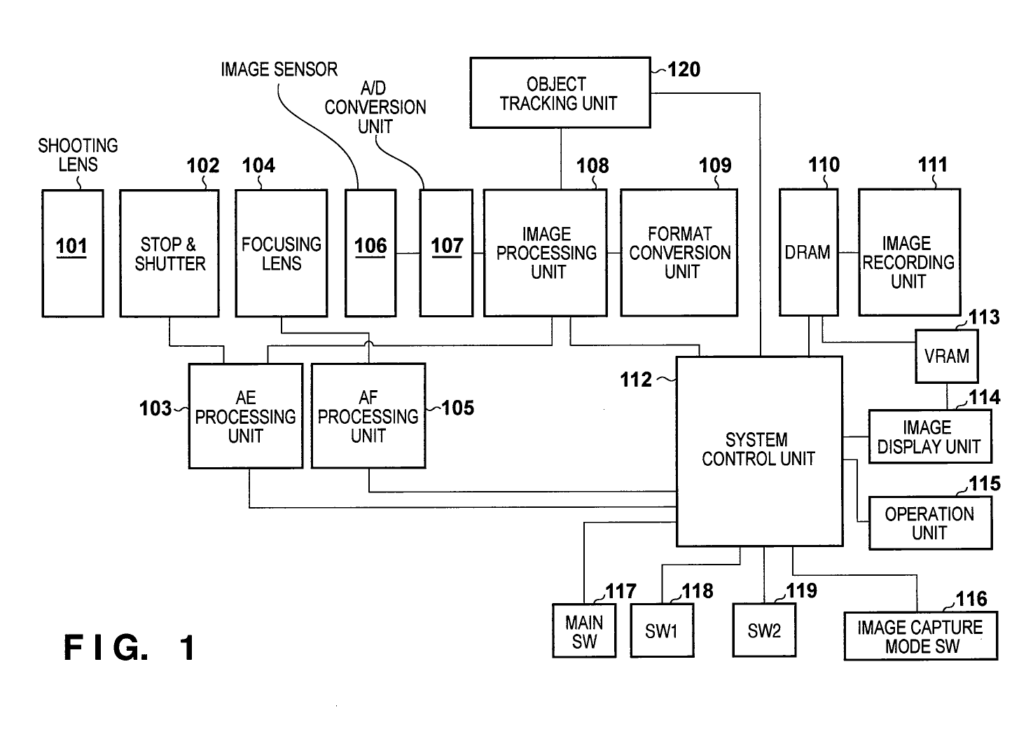

The first embodiment of the present invention will be described below with reference to FIGS. 1 to 8C. FIG. 1 is a block diagram showing the configuration of a digital camera as the first embodiment of an image capture apparatus according to the present invention.

Referring to FIG. 1, reference numeral 101 denotes a shooting lens (imaging optical system) including a zoom mechanism; 102, a stop & shutter which controls the amount of light; 103, an AE processing unit; 104, a focusing lens used to focus on an image sensor 106 (to be described later); and 105, an AF processing unit. Reference numeral 106 denotes an image sensor which serves as a light-receiving means or a photo-electric conversion means for converting light (object image) reflected by an object imaged by the shooting lens 101 into an electrical signal, and outputs an image signal obtained by conversion as an output signal. Reference numeral 107 denotes an A/D conversion unit which includes a CDS circuit for eliminating noise output from the image sensor 106, and a nonlinear amplifier circuit for performing nonlinear amplification before A/D conversion. Reference numeral 108 denotes an image processing unit; 109, a format conversion unit; 110, a high-speed internal memory (which is typified by, for example, a random access memory and will be referred to as a DRAM hereinafter); and 111, an image recording unit which includes a recording medium such as a memory card and its interface.

Reference numeral 112 denotes a system control unit (to be referred to as a CPU hereinafter) which controls a system such as an image capture sequence; and 113, an image display memory (to be referred to as a VRAM hereinafter). Reference numeral 114 denotes an image display unit which displays an image, performs display for operation assistance, displays the camera state, and displays an image capture frame and a tracking area or a distance measurement area at the time of image capture. Reference numeral 115 denotes an operation unit used to externally operate the camera; 116, an image capture mode switch used to select, for example, a tracking AF mode; and 117, a main switch used to power a system. Reference numeral 118 denotes a switch (to be referred to as a switch SW1 hereinafter) used to perform image capture standby operations such as AF and AE; and 119, a switch (to be referred to as a switch SW2 hereinafter) used to perform image capture after operating the switch SW1.

The DRAM 110 is used as, for example, a high-speed buffer or a working memory in image compression/expansion, which serves as a temporary image storage means. The operation unit 115 includes, for example, a menu switch used to perform various types of settings such as setting of the image capture function of the image capture apparatus and settings in image playback, a zoom lever used to issue an instruction to execute the zoom operation of the shooting lens, an operation mode switch used for switching between an image capture mode and a playback mode, and a touch panel or a select button used to designate a specific position in an image. Reference numeral 120 denotes an object tracking unit which detects and tracks an arbitrary object within a frame (on a frame) based on color information or luminance information in a video signal, processed by the image processing unit 108, when the operation unit 115 selects this object. The object tracking unit 120, for example, stores at least one of color information and luminance information included in a selected object area, and extracts, using the stored information, an area with a highest correlation with the selected object area from an image different from the image in which the object is selected. Note that the object tracking unit 120 need not use a focus evaluation value in detecting the selected object.

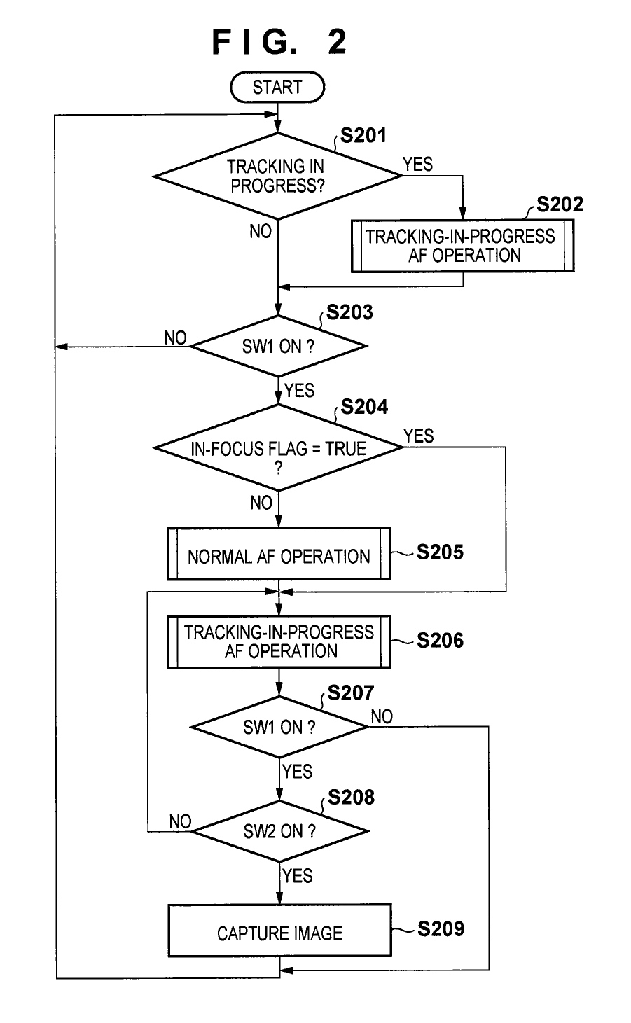

The operation of the digital camera according to the first embodiment of the present invention will be described in detail below with reference to FIGS. 2 to 8C.

Referring to FIG. 2, in step S201, the user selects an arbitrary object within a frame using the operation unit 115 to check whether a tracking operation is in progress. If YES is determined in step S201, the process advances to step S202; otherwise, the process directly advances to step S203. At this time, a tracking operation may be enabled only when a tracking AF mode is selected by the image capture mode switch 116.

In step S202, a tracking-in-progress AF operation (to be described later) is performed, and the process advances to step S203. In step S203, the state of the switch SW1 is checked. If the switch SW1 is ON, the process advances to step S204; otherwise, the process returns to step S201. In step S204, it is checked whether an in-focus flag (to be described later) is TRUE. If YES is determined in step S204, the process directly advances to step S206; otherwise, the process advances to step S205. In step S205, a normal AF operation (to be described later) is performed.

In step S206, a tracking-in-progress AF operation (to be described later) is performed, and the process advances to step S207. In step S207, the state of the switch SW1 is checked. If the switch SW1 is ON, the process advances to step S208; otherwise, the process returns to step S201. In step S208, the state of the switch SW2 is checked. If the switch SW2 is ON, the process advances to step S209; otherwise, the process returns to step S206. In step S209, an image capture operation is performed, and the process returns to step S201.

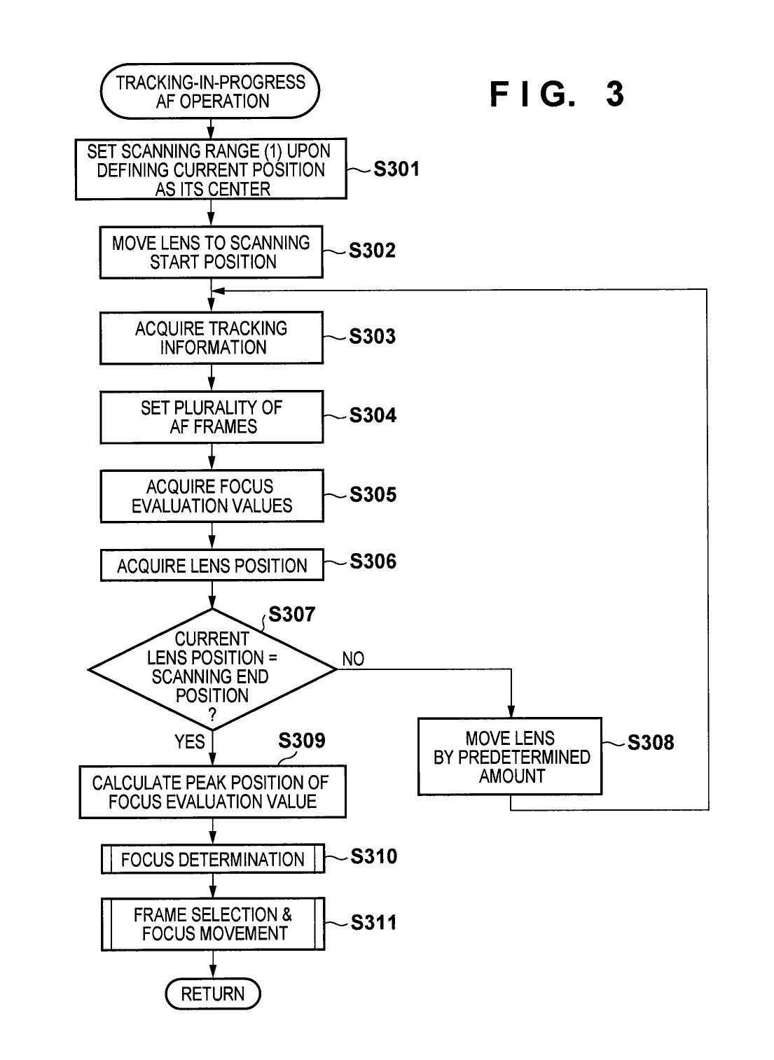

FIG. 3 is a flowchart for explaining a tracking-in-progress AF operation in steps S202 and S206 in FIG. 2. First, in step S301, scanning range (1) is set upon defining the current position as its center, and the process advances to step S302. Note that a narrowest possible range within which a given AF accuracy can be ensured is set as scanning range (1) to avoid degradation in resolution of a live image due to a variation in focus.

In step S302, the focusing lens 104 is moved to the scanning start position based on scanning range (1) determined in step S301, and the process advances to step S303. In step S303, tracking information, which is obtained by the object tracking unit 120 and includes for example, the central position and size of the current tracked object area, is acquired, and the process advances to step S304. In step S304, a plurality of AF frames (focus detection areas) are set with reference to the tracking information acquired in step S303, and the process advances to step S305.

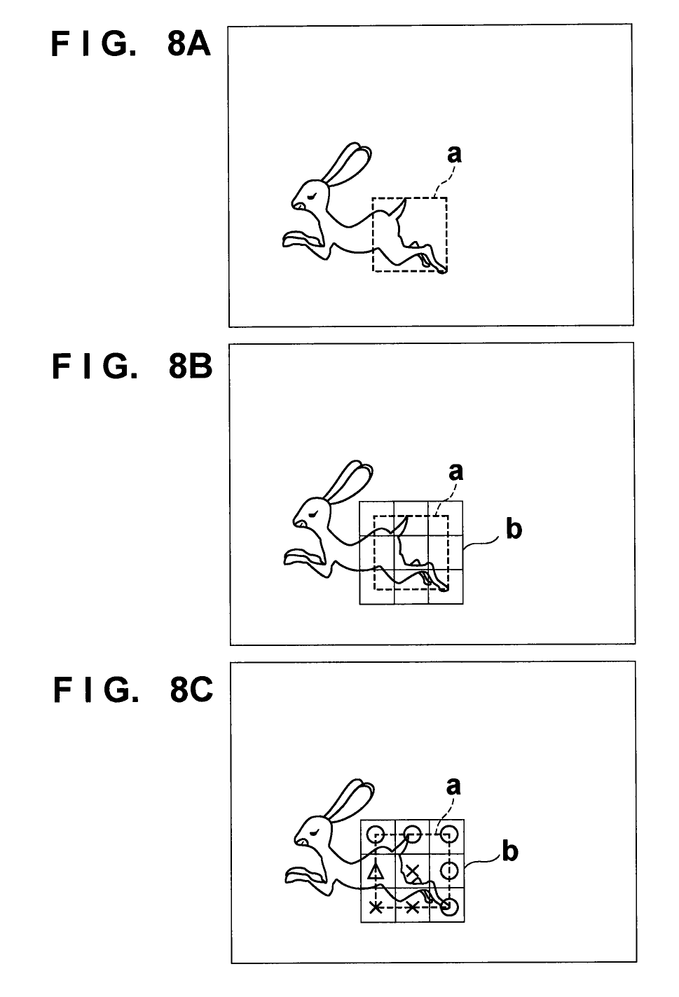

A method of setting a plurality of AF frames will be described in detail herein with reference to FIG. 8B. In this case, N×M AF frames are set as a plurality of AF frames (N=3 and M=3 in FIG. 8B) upon defining the central position of the tracking area (an area “a” in FIG. 8B) obtained in step S303 as their center. The size of each AF frame is set as small as possible so as to prevent focusing on the background, within the range in which a given AF accuracy can be ensured. Therefore, the size of each AF frame is smaller than a minimum size which can be set for the tracked object area. Also, to focus on the object even if it falls outside the tracking area, the size of each AF frame is set such that the overall range within which a plurality of AF frames are set is wider than the tracking area.

In step S305, the CPU 112 stores, in the DRAM 110, a focus evaluation value indicating the focus state at the current focusing lens position in each of the plurality of AF frames set in step S304, and the process advances to step S306. In step S306, the current position of the focusing lens 104 is acquired, and the CPU 112 stores the data of this current position in the DRAM 110, and the process advances to step S307. In step S307, the CPU 112 checks whether the current position of the focusing lens 104 is identical to the scanning end position. If YES is determined in step S307, the process advances to step S309; otherwise, the process advances to step S308.

In step S308, the AF processing unit 105 moves the focusing lens 104 by a predetermined amount in the direction in which scanning ends, and the process returns to step S303. In step S309, a focus position at which the focus evaluation value acquired in step S305 has a peak is calculated, and the process advances to step S310. In step S310, focus determination (to be described later) is performed, and the process advances to step S311. In step S311, frame selection & focus movement (to be described later) are performed, and the process ends.

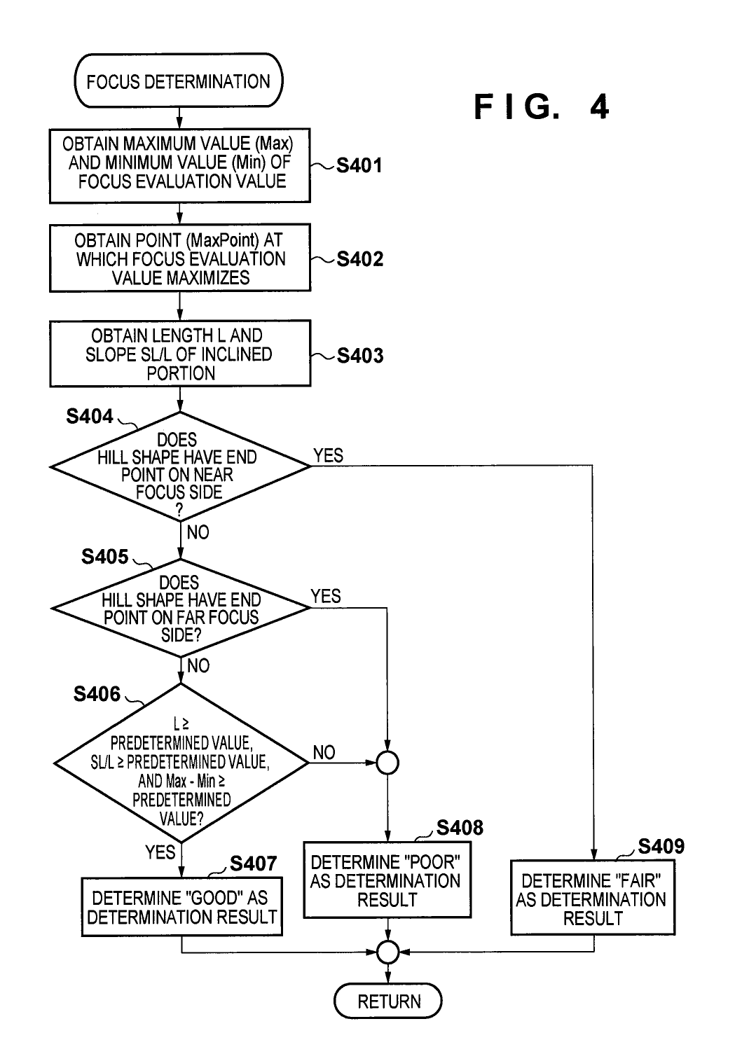

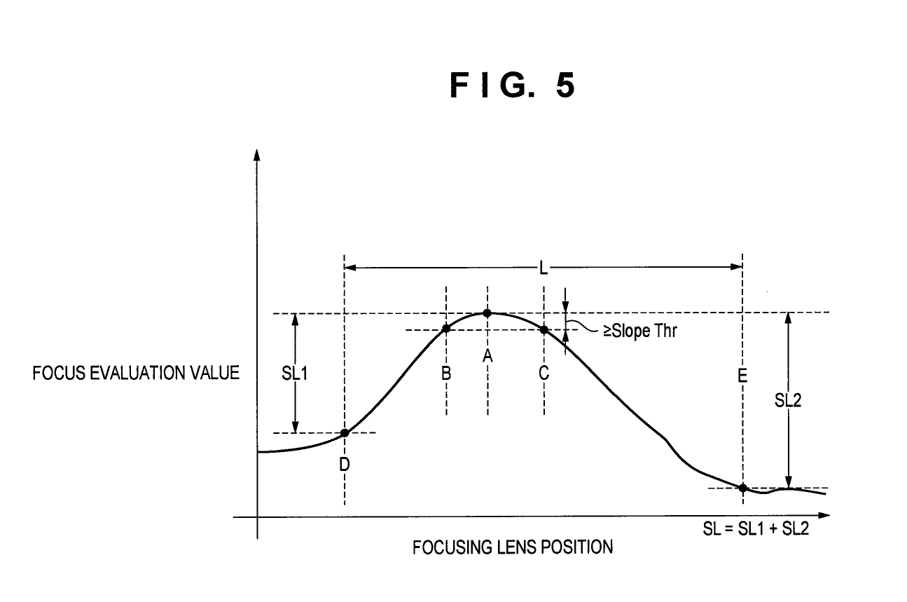

A subroutine for focus determination in step S310 of FIG. 3 will be described below with reference to FIGS. 4 and 5.

Except for a situation in which, for example, the same frame includes objects at near and far focal lengths, the focus evaluation value has a hill shape, as shown in FIG. 5, in which the abscissa indicates the focusing lens position, and the ordinate indicates the focus evaluation value. Hence, focus determination can be performed by determining the hill shape from the difference between the maximum and minimum values of the focus evaluation value, the length of a portion inclined with a slope equal to or larger than a specific value (SlopeThr), and the gradient of the inclined portion.

The determination result obtained by focus determination is output as “good” or “poor” as follows.

Good: The object has a sufficient contrast and exists at a distance that falls within the scanning distance range.

Poor: The object has an insufficient contrast or is positioned at a distance that falls outside the scanning distance range.

Also, “fair” is determined for a determination result obtained when the object is positioned to fall outside the scanning distance range in the near focus direction, among “poor” determination results.

FIG. 4 is a flowchart for explaining focus determination in step S310 of FIG. 3. First, in step S401, the maximum and minimum values of the focus evaluation value are obtained. In step S402, a scanning point at which the focus evaluation value maximizes is obtained, and the process advances to step S403. In step S403, lengths L and SL (see FIG. 5) used to determine the hill shape are obtained from the scanning point and the focus evaluation value, and the process advances to step S404.

In step S404, it is determined whether the hill shape has an end point on the near focus side. An end point on the near focus side is determined when the scanning point at which the focus evaluation value maximizes is the near focus position (distance information) of a predetermined scanning range, and the difference between the focus evaluation value at the scanning point corresponding to the near focus position and that at a scanning point closer to the far focus position by one point than the scanning point corresponding to the near focus position is equal to or larger than a predetermined value. If YES is determined in step S404, the process advances to step S409; otherwise, the process advances to step S405.

In step S405, it is determined whether the hill shape has an end point on the far focus side. An end point on the far focus side is determined when the scanning point at which the focus evaluation value maximizes is the far focus position of a predetermined scanning range, and the difference between the focus evaluation value at the scanning point corresponding to the far focus position and that at a scanning point closer to the near focus position by one point than the scanning point corresponding to the far focus position is equal to or larger than a predetermined value. If YES is determined in step S405, the process advances to step S408; otherwise, the process advances to step S406.

In step S406, it is determined whether the length L of a portion inclined with a slope equal to or larger than a specific value is equal to or larger than a predetermined value, the average value SL/L of the slope of the inclined portion is equal to or larger than a predetermined value, and the difference between the maximum value (Max) and minimum value (Min) of the focus evaluation value is equal to or larger than a predetermined value. If YES is determined in step S406, the process advances to step S407; otherwise, the process advances to step S408.

In step S407, the obtained focus evaluation value has a hill shape, the object has good contrast, and focus adjustment is possible, so “good” is determined as a determination result. In step S408, the obtained focus evaluation value has no hill shape, the object has poor contrast, and focus adjustment is impossible, so “poor” is determined as a determination result. In step S409, the obtained focus evaluation value has no hill shape but nonetheless continues to rise in a direction to come closer to the near focus position and may have an object peak on the near focus side, so “fair” is determined as a determination result. Focus determination is performed in the above-mentioned way.

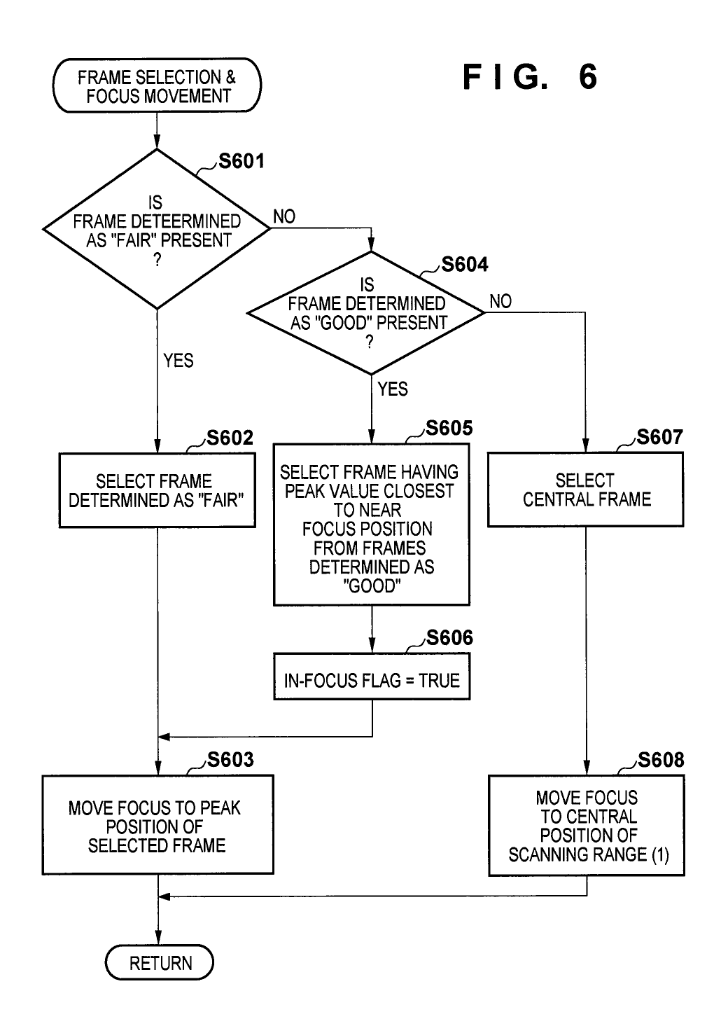

FIG. 6 is a flowchart for explaining frame selection & focus movement in step S311 of FIG. 3. First, in step S601, it is checked whether a frame determined as “fair” is present among the plurality of AF frames. If YES is determined in step S601, the process advances to step S602; otherwise, the process advances to step S604. In step S602, the frame determined as “fair” is selected, and the process advances to step S603. Note that if a plurality of frames determined as “fair” are present, a frame having a peak position for the focus evaluation value, which is closest to the near focus position, is selected. If even a plurality of frames having the same peak position for the focus evaluation value are present, the order of priority of frame selection is determined in advance.

In step S604, it is checked whether a frame determined as “good” is present among the plurality of AF frames. If YES is determined in step S604, the process advances to step S605; otherwise, the process advances to step S607. In step S605, a frame having a peak position for the focus evaluation value, which is closest to the near focus position, is selected from frames determined as “good”, and the process advances to step S606. If even a plurality of frames having the same peak position for the focus evaluation value are present, the order of priority of frame selection is determined in advance. In step S606, an in-focus flag is changed to TRUE, and the process advances to step S603.

In step S607, the central frame among the plurality of set AF frames is selected, and the process advances to step S608. In step S608, the focusing lens 104 is moved to the central position of scanning range (1) set in step S301, and the process ends.

If, for example, the focus determination results of the plurality of AF frames are obtained as shown in FIG. 8C, the left frame on the middle row, which is determined as “fair”, is selected, and the focus is driven to the peak position of the focus evaluation value of this frame.

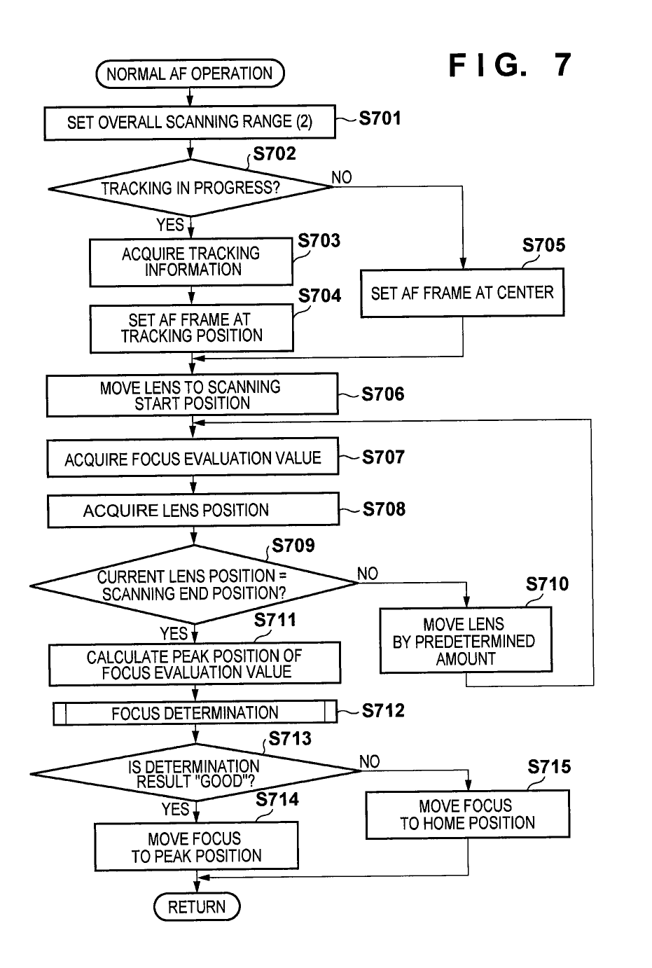

FIG. 7 is a flowchart for explaining a normal AF operation in step S205 of FIG. 2. In step S701, scanning range (2) which assumes the overall distance range within which image capture is possible is set, and the process advances to step S702. In step S702, an arbitrary object within the frame is selected using the operation unit 115 to check whether a tracking operation is in progress. If YES is determined in step S702, the process advances to step S703; otherwise, the process advances to step S705. In step S703, tracking information which is obtained by the object tracking unit 120 and includes, for example, the central position and size of the current tracked object area is acquired, and the process advances to step S704. In step S704, an AF frame is set based on the tracking information acquired in step S703, and the process advances to step S706. Although only one AF frame is set in this case, a plurality of AF frames may be set. Note that when only one AF frame is set, its size may be set larger than that of the tracking area.

In step S705, the AF frame is set at the frame center, and the process advances to step S706. In this case as well, either one or a plurality of AF frames may be set. In step S706, the focusing lens 104 is moved to the scanning start position based on scanning range (2) determined in step S701, and the process advances to step S707. In step S707, the CPU 112 stores, in the DRAM 110, the focus evaluation value at the current focusing lens position in the AF frame set in step S704 or S705, and the process advances to step S708.

In step S708, the current position of the focusing lens 104 is acquired, and the CPU 112 stores the data of this current position in the DRAM 110, and the process advances to step S709. In step S709, the CPU 112 checks whether the current position of the focusing lens 104 is identical to the scanning end position. If YES is determined in step S709, the process advances to step S711; otherwise, the process advances to step S710. In step S710, the AF processing unit 105 moves the focusing lens 104 by a predetermined amount in the direction in which scanning ends, and the process returns to step S707.

In step S711, a focus position at which the focus evaluation value acquired in step S707 has a peak is calculated, and the process advances to step S712. In step S712, the above-mentioned focus determination is performed, and the process advances to step S713. In step S713, it is checked whether “good” is determined upon focus determination in step S712. If YES is determined in step S713, the process advances to step S714; otherwise, the process advances to step S715. In step S714, the focusing lens 104 is moved to the peak position of the focus evaluation value, and the process ends. In step S715, the focusing lens 104 is moved to the home position, and the process ends.

As has been described above, according to the above-mentioned first embodiment, by setting a plurality of AF frames to fall within a range wider than a tracking area upon defining the central position of the tracking area as its center, the apparatus can continue to focus on the target object even if the tracking area includes the background.

### Second Embodiment

The second embodiment is different from the first embodiment in setting of a plurality of AF frames and in frame selection. A tracking-in-progress AF operation in the second embodiment will be described below with reference to FIGS. 2, 9, 10A, 10B, and 10C.

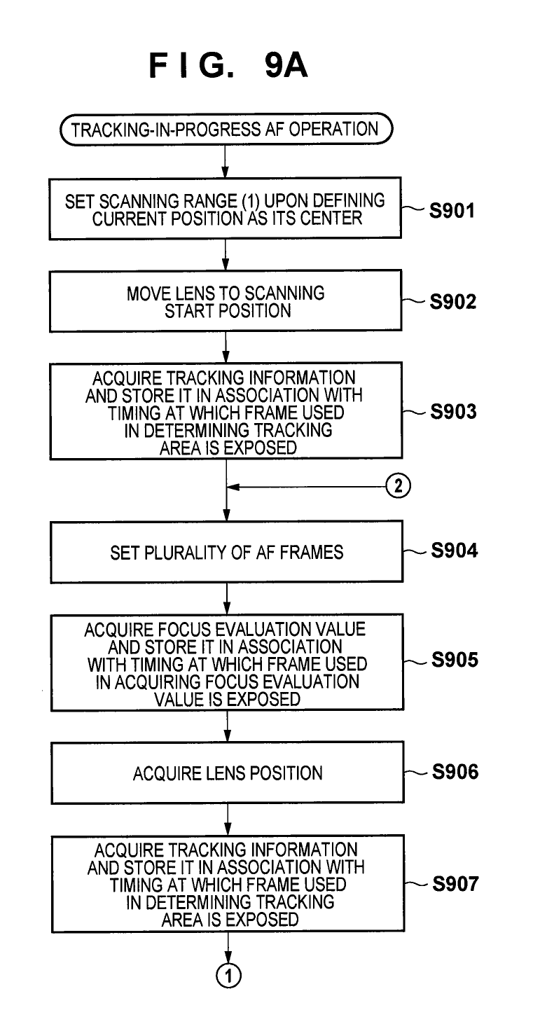

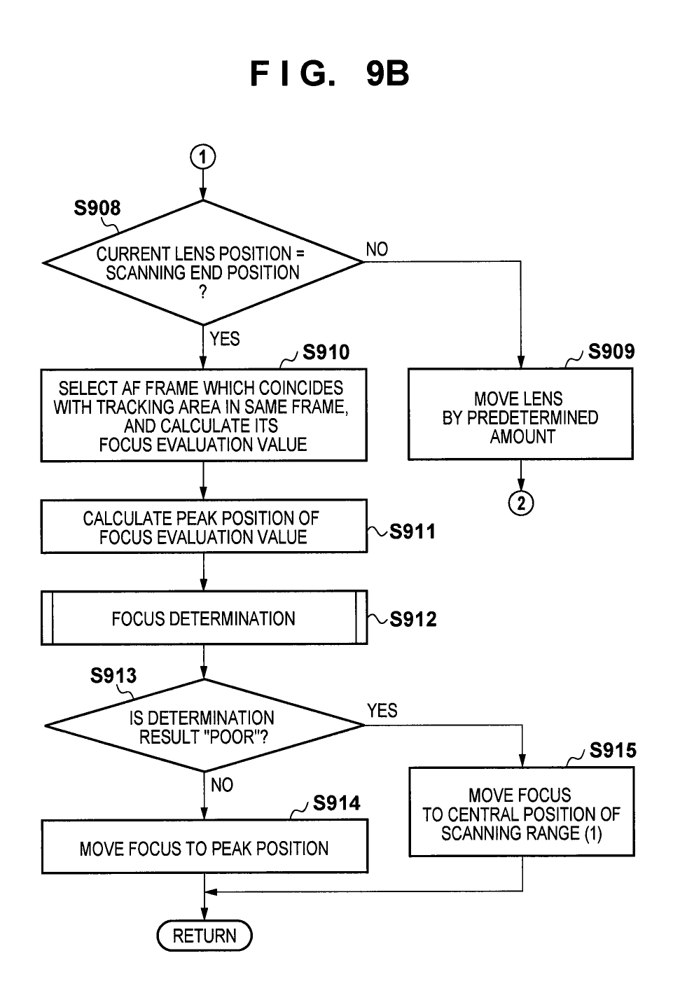

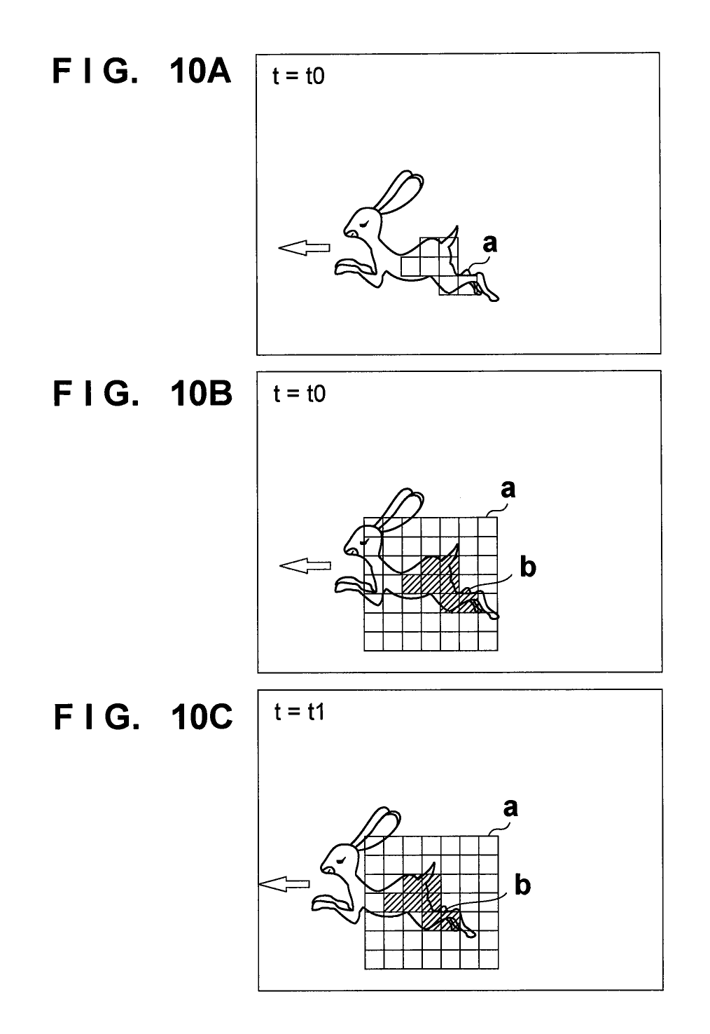

FIGS. 9A and 9B are flowcharts for explaining a tracking-in-progress AF operation in steps S202 and S206 of FIG. 2 according to the second embodiment. First, in step S901, scanning range (1) is set upon defining the current position as its center, and the process advances to step S902. Note that a narrowest possible range within which a given AF accuracy can be ensured is set as scanning range (1) to avoid degradation in resolution of a live image due to a variation in focus. In step S902, a focusing lens 104 is moved to the scanning start position based on scanning range (1) determined in step S901, and the process advances to step S903. In step S903, tracking information obtained by an object tracking unit 120 is acquired, and the process advances to step S904. The tracking information means herein an area (to be referred to as a tracked object area hereinafter) which is determined as a block including a tracked object, based on color information or luminance information, among a plurality of blocks obtained by dividing a frame. This information is stored in association with the timing at which an image frame used in determination is exposed. If, for example, an area “a” surrounded by a solid line in FIG. 10A is determined as a tracked object area, this region and a timing t=t0 at which a frame used in determination is exposed are stored in association with each other.

In step S904, a plurality of AF frames are set based on the tracking information acquired in step S903, and the process advances to step S905. At this time, N×M AF frames are set as a plurality of AF frames (N=7 and M=7 in an area “a” of FIG. 10B) upon defining the barycentric position of the tracked object area (an area “b” in FIG. 10B) as their center. This tracked object area (the area “b” in FIG. 10B) is the same as the area “a” in FIG. 10A. Also, each AF frame is set in accordance with the size and position of a frame division block used in determining the tracked object area.

In step S905, the focus evaluation value at the current position of the focusing lens 104 in each of the plurality of AF frames set in step S904 is stored in a DRAM 110, and the process advances to step S906. At this time, the focus evaluation value is stored in association with the timing (for example, t=t1) at which an image frame for which a focus evaluation value is acquired is exposed. In step S906, the current position of the focusing lens 104 is acquired, and a CPU 112 stores the data of this current position in the DRAM 110, and the process advances to step S907.

In step S907, tracking information obtained by the object tracking unit 120 is acquired, as in step S903, and the process advances to step S908. If, for example, a hatched area “b” in FIG. 10C is determined as a tracked object area, this region and a timing t=t1 at which a frame used in determination is exposed are stored in association with each other.

In step S908, the CPU 112 checks whether the current position of the focusing lens 104 is identical to the scanning end position. If YES is determined in step S908, the process advances to step S910; otherwise, the process advances to step S909. In step S909, an AF processing unit 105 moves the focusing lens 104 by a predetermined amount in the direction in which scanning ends, and the process returns to step S904. In step S910, an AF frame which coincides with the tracked object area in the same image frame is selected based on the focus evaluation value acquired in step S905, and the pieces of tracking information acquired in steps S903 and S907. New focus evaluation values for those areas are calculated, and the process advances to step S911.

If, for example, a plurality of AF frames are set in step S904, as exemplified in an area “a” of FIG. 10C, focus evaluation values for the AF frames set in step S904 are obtained and stored, regardless of the object position at a timing t=t1 at which an image frame for which a focus evaluation value is acquired is exposed. After that, when the object tracking unit 120 selects a tracked object area (the area “b” in FIG. 10C) from the image frame exposed at the timing t=t1, a new focus evaluation value is obtained by reading out a focus evaluation value for the newly selected tracked object area among the stored focus evaluation values, and adding the former evaluation value to the latter evaluation values. At this time, if a given AF accuracy cannot be obtained because, for example, only one AF frame coincides with the tracked object area, the sum of a predetermined number of AF frames in its vicinity may be obtained.

The reason why an arrangement in which a focus evaluation value for an AF frame in an image frame at a timing t=t1 is obtained after a tracked object area is detected from the image frame exposed at the timing t=t1 is not adopted will be explained herein. The object tracking unit 120 performs an arithmetic operation for obtaining at least one of luminance information and color information from an image, and extracting an area with a highest correlation with a tracked object area stored in advance, and this requires a processing time longer than that required to obtain a focus evaluation value for an AF frame. Therefore, to set an AF frame and obtain a focus evaluation value after a tracked object area is detected, its image frame must be stored in another memory in order to obtain a focus evaluation value. In contrast to this, an arrangement in which a focus evaluation value for an AF frame set in the previous image frame is obtained, as in this embodiment, obviates the need to store an image frame in another memory in order to obtain a focus evaluation value.

In step S911, an in-focus position at which the focus evaluation value calculated in step S910 has a peak is calculated, and the process advances to step S912. In step S912, the above-mentioned focus determination is performed, and the process advances to step S913. In step S913, it is checked whether “poor” is determined as a result of determination in step S912. If YES is determined in step S912, the process advances to step S915; otherwise, the process advances to step S914. In step S914, the focusing lens 104 is moved to the peak position of the focus evaluation value, and the process ends. In step S915, the focusing lens 104 is moved to the central position of scanning range (1) set in step S901, and the process ends.

As has been described above, according to the second embodiment, a plurality of AF frames are set based on the past tracking information and their focus evaluation values are acquired, and then an AF frame is selected from the plurality of AF frames based on the current tracking information and a new focus evaluation value is calculated, thereby making it possible to continue to focus on a moving target object without wastefully prolonging the processing time.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2010-179009, filed Aug. 9, 2010 and 2011-132710, filed Jun. 14, 2011, which are hereby incorporated by reference herein in their entirety.

What is claimed is:

1. An image capture apparatus comprising:
an image sensor which photo-electrically converts an object image formed by an imaging optical system;
a detection unit which detects an object area, in which a target object to be focused exists, on a frame of said image sensor, based on at least one of color information and luminance information of an image obtained from an output signal from said image sensor;
a setting unit which sets a plurality of focus detection areas, used to detect a focus state of the imaging optical system, with reference to the object area detected by said detection unit;
a selection unit which selects a focus detection area, in which the target object exists, from the plurality of focus detection areas; and
a focus adjusting unit which performs focus adjustment by moving the imaging optical system based on the output signal from said image sensor in the focus detection area selected by said selection unit,
wherein an overall range of the plurality of focus detection areas is wider than the object area, and each of the plurality of focus detection areas is smaller than a minimum size which can be set for the object area.

2. The apparatus according to claim 1, wherein said setting unit sets the plurality of focus detection areas upon defining a central position of the object area as a center thereof.

3. The apparatus according to claim 1, wherein said selection unit selects the focus detection area, in which the target object exists, based on object distance information in the plurality of focus detection areas.

4. The apparatus according to claim 1, wherein said selection unit selects the focus detection area, in which the target object exists, based on at least one of object color information and luminance information in the plurality of focus detection areas.

5. The apparatus according to claim 4, wherein said selection unit selects the focus detection area, in which the target object exists, based on at least one of object color information and luminance information in an image identical to an image in which a focus evaluation value indicating the focus state of the imaging optical system is acquired for each of the plurality of focus detection areas.

6. The apparatus according to claim 1, wherein said focus adjusting unit performs focus adjustment based on a sum of output signals from said image sensor in the focus detection area selected by said selection unit.
